(19) United States
(12) Patent Application Publication
(10) Pub. No.: US 2008/0145008 A1
(43) Pub. Date: Jun. 19, 2008

(54) Cable assembly with selectively extendable tether

(76) Inventors: Christopher Paul Lewallen, Hudson, NC (US); James P. Luther, Hickory, NC (US); Hieu V. Tran, Charlotte, NC (US); Joseph T. Cody, Hickory, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/638,770

(22) Filed: Dec. 14, 2006

(51) Int. Cl. G02B 6/44

(52) U.S. Cl. 385/100

(57) ABSTRACT

A cable assembly including a fiber optic cable and at least one network access point positioned on the cable at which at least one optical fiber within the cable is accessed and preterminated. The cable assembly comprises a tether adapted to be selectively extended and including at least one tether optical fiber therein that is optically connected to the at least one optical fiber that is preterminated, and a tether storage member for storing at least a portion of the tether therein, wherein at least one of the at least one optical fiber that is preterminated and the at least one tether optical fiber comprises a bend performance optical fiber.

### BACKGROUND OF THE INVENTION

1. Field of the Invention

The present invention relates generally to fiber optic cable assemblies including at least one network access point, and more particularly, to network access points that include a length of tether and tether slack about the access point, and wherein a portion of the assembly utilizes bend performance optical fiber to maintain a low-profile network access point.

2. Description of the Related Art

Optical fiber is increasingly being used for a variety of broadband applications including voice, video and data transmissions. As a result, there is a need for connecting locations to a fiber optic distribution cable in order to provide services to an end user, commonly referred to as a subscriber. In this regard, fiber optic networks are being developed that deliver “fiber-to-the-curb” (FTTC), “fiber-to-the-business” (FTTB), “fiber-to-the-home” (FTTH) and “fiber-to-the-premises” (FTTP), referred to generically as “FTTx.” networks. To extend these optical networks, distribution cables typically include network access points at predetermined positions along cable lengths for providing access to one or more optical fibers within the cable. These network access points, referred to herein as “NAPs”, typically involve branching, and also commonly splicing, of preterminated optical fibers of the distribution cable to fibers of another cable, referred to generically herein as a “tether”. The tether may be used to extend the fiber optic network to locations within reach of the tether. NAPs may be created in the field or in the factory and are preferably enclosed to protect the fibers and splices. In some cable assemblies available from Corning Cable Systems of Hickory, N.C., the NAPs are substantially encapsulated within a flexible overmolded body, thus providing flexible NAPs or “FlexNAPs”.

One problem with factory prepared FlexNAPs is that distribution cables and their attached tethers must be reeled, maintained and installed as a whole assembly, such as through small diameter conduit or around aerial installation pulleys and rollers. Cable assemblies may require fairly long lengths of tether, thus making installation even more difficult. With respect to conduit installation environments in particular, telecommunications service providers require installation through conduits having a diameter of about 1.25 inches. Conventional cable assemblies with rigid closures and attached tethers are typically unable to be installed through such environments due to size and flexibility limitations. Conventional cable assemblies with overmolded bodies and attached tethers may be capable of being installed through such small diameter conduit, but require that the optical fibers of the distribution cable and tether be maintained substantially longitudinal without fiber slack because of bending limitations in the fibers in such a small diameter package. In other words, the 1.25 inch diameter constraint does not allow for slack loops, coils, or direction changes of the optical fibers of the assembly without violating a minimum bend radius of the fibers. Thus, since tether slack can not be stored within the assembly, it is necessary to maintain the full length of predetermined tether length substantially longitudinal with the distribution cable during installation. This creates having to store slack when connecting a location closer than the full reach of the tether. Once installed, tether slack may be looped and stored externally, but not in a low-profile or aesthetically pleasing manner.

In this regard, what is desired is a small diameter cable assembly capable of accommodating tether slack about the NAP, thus providing tether slack for an extendable or telescoping tether. The cable assembly would desirably have a largest cross-sectional diameter less than about 1.25 inches, thus facilitating installation through small diameter conduit. Tether slack would allow an installer to withdraw only the amount of tether length necessary to connect a location to the distribution cable, thus providing an aesthetically pleasing installed assembly. Further, by storing tether slack length during installation and until needed, the cable assembly is better protected from damage and the environment. Still further, what is desired is a cable assembly including an attached tether and flexible NAP that utilizes bend performance optical fiber in at least a portion of the assembly in order to provide tether slack in a small diameter package. Still further, what is desired is a cable assembly that provides long lengths of tether slack with no outer diameter penalty over existing tether assemblies.

### BRIEF SUMMARY OF THE INVENTION

To achieve the foregoing and other objects, and in accordance with the purposes of the invention as embodied and broadly described herein, the present invention provides various embodiments of a fiber optic cable assembly including a distribution cable and at least one Network Access Point (“NAP”) at a predetermined position along the cable length for providing access to at least one preterminated optical fiber within the cable. In one embodiment, at least one preterminated optical fiber is severed and routed away from the remaining uncut fibers of the cable. The at least one preterminated fiber is spliced or otherwise optically connected to at least one optical fiber of a tether. More than one tether may be attached or secured about a single NAP, and multiple tethers may be directed out one or both ends of a NAP. Multiple NAPs may be installed in the factory along the length of a distribution cable to provide multiple branch points on the cable. A NAP may be created by removing a portion of the cable sheath to access buffer tubes or ribbonized fibers within the cable. An assembled NAP includes a protective body for protecting the cable access point and attaching the at least one tether in a substantially sealed manner. In one embodiment, a NAP includes a flexible overmolded body that substantially encapsulates the NAP, thus being flexible to facilitate installation and encapsulating to provide improved sealing performance. The overmolded body may be made from a flowable material that is provided to the NAP in a controlled manner and allowed to cure forming a desired shape.

In one embodiment, the distribution cable defines space within sufficient to accommodate a looping or a 180 degree turn of the at least one tether fiber, such as a large center core cable or cables including multiple cavities. In another embodiment, the distribution cable includes external tether slack storage structure for storing and maintaining tether slack, and wherein the slack is looped or includes at least one 180 degree turn. In still another embodiment, the cable assembly includes a tether having space sufficient to accommodate tether slack in the form of a loop or at least one 180 degree turn. In all embodiments described herein, the cable assembly includes tether slack stored about the NAP such that the tether may be extended or telescoped after installation and as needed to extend the optical network. While not a limiting portion of the present invention, a tether may terminate at its downstream end in splice ready optical fibers, connectorized optical fibers, in a multi-port connection terminal or in any other assembly. The tether may include coated or buffered optical fibers alone or routed within protected tubing.

In another embodiment, the present invention provides a cable assembly for length error compensation that includes an internal or external cavity for maintaining tether slack with no outer diameter penalty over existing tether assemblies. In one embodiment, the cable assembly includes a lanyard to prevent over travel of an extending tether. The lanyard may be stored at an end of the cavity and deployed parallel to a length or ribbon slack as the tether is telescoped forward. The lanyard may include, but is not limited to, a single strand of Kevlar. The cable assembly may further include a removable seal that is removed to deploy the tether to the required length and then reseal the junction. The seal may include, but is not limited to, vinyl 77 or an equivalent. The cable assembly may further include a decoupling of the cavity and the tether from the distribution cable to prevent bend related issues. In all embodiments, at least a portion of the cable assembly includes bend optimized fiber, low bend sensitivity fiber, bend insensitive fiber or photonic bandgap fiber, all of which are referred to generically herein as “bend performance optical fiber”. Bend performance optical fiber allows the tether slack to loop or make a 180 degree turn within its cavity in the small diameter cavity without appreciable loss. The bend performance fiber of the present invention allows for loops or 180 degree turns of slack in an assembly having an outer diameter less than about 2.0 inches, more preferably less than about 1.5 inches, even more preferably less than about 1.25 inches.

In another embodiment, the cable assembly includes standard single mode fiber spliced to bend performance fiber at the NAP. In one embodiment, the bend performance fiber is a microstructured fiber and allows a 180 degree turn for providing an extendible/retractable tether. The tether may be in the form of single or ribbon fibers stored within a space about the NAP. The fibers may be connectorized and a protective tubing installed after installation. Thus, the present invention provides an ultra low-profile assembly with tether length stored about the NAP, in one embodiment within a large center core cable, and withdrawn as needed. A tool may be used to install spliced slack within the cable. Multiple windows may be created on the distribution cable to facilitate removal. The tool may be removed after use or may remain in place as a minimum bend radius control device. Throughout all embodiments, a variety of cables and connectors may be used and are within the scope of the present invention. Cable and tether lengths may be varied per application.

Additional features and advantages of the invention will be set forth in the detailed description which follows, and in part will be readily apparent to those skilled in the art from that description or recognized by practicing the invention as described herein, including the detailed description which follows, the claims, as well as the appended drawings. It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

These and other features, aspects and advantages of the present invention are better understood when the following detailed description of the invention is read with reference to the accompanying drawings, in which:

FIG. 1 is a side view of a cable assembly including a flexible NAP and external storage for tether slack for an extendable/retractable tether;

FIG. 2A is a cut-away perspective view of the cable assembly of FIG. 1 shown with an external tether in a retracted position;

FIG. 2B is an enlarged cut-away side view of the cable assembly of FIG. 2A illustrating the cable access portion of the assembly;

FIG. 2C is an enlarged cut-away perspective view of the cable assembly of FIG. 2A illustrating the coiled lanyard;

FIG. 3A is a cut-away perspective view of the cable assembly of FIG. 1 shown with the tether in an extended position;

FIG. 3B is an enlarged cut-away side view of the cable assembly of FIG. 3A illustrating the cable access portion of the assembly;

FIG. 3C is an enlarged cut-away side view of the cable assembly of FIG. 3A illustrating a portion of the telescoping tether;

FIG. 4A is a perspective view of a cable assembly including an internally stored extendable tether shown in a retracted position;

FIG. 4B is a perspective view of the cable assembly of FIG. 4A shown with the tether in an extended position;

FIG. 5A-C are perspective views illustrating creation stages of an extendable/retractable tether including bend performance optical fiber;

FIG. 6 is a schematic diagram illustrating a cross-section of one embodiment of a bend performance optical fiber operable for performing a 180 degree turn within the cable assembly; and

FIG. 7 is a digital cross-sectional image of a microstructured bend performance optical fiber illustrating an annular hole-containing region comprised of non-periodically disposed holes.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the embodiments set forth herein. These exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Referring to the various figures, the present invention provides fiber optic cable assemblies including a main cable, such as a distribution cable, and at least one Network Access Point (“NAP”) positioned along the cable length for providing access to at least one preterminated optical fiber within the cable. The at least one preterminated optical fiber is severed, routed and spliced or otherwise optically connected to at least one optical fiber of a tether. The term “tether” is used herein to generically describe any branch cable, drop cable and secondary distribution, among others. More than one tether may be attached or secured about a single NAP, and multiple tethers may be directed out one or both ends of a NAP. Multiple NAPs may be installed along the length of a cable to provide multiple branch points on the cable. A NAP may be created by removing a portion of the cable sheath to access buffer tubes, fibers or ribbonized fibers within the cable. An assembled NAP includes a protective body for protecting the cable access point and optionally attaching the at least one tether in a substantially sealed manner. In one embodiment, a NAP includes a flexible overmolded body that substantially encapsulates the NAP, thus being flexible to facilitate installation and encapsulating to provide improved sealing performance. The overmolded body may be made from a flowable material that is provided to the NAP in a controlled manner and allowed to cure forming a desired shape.

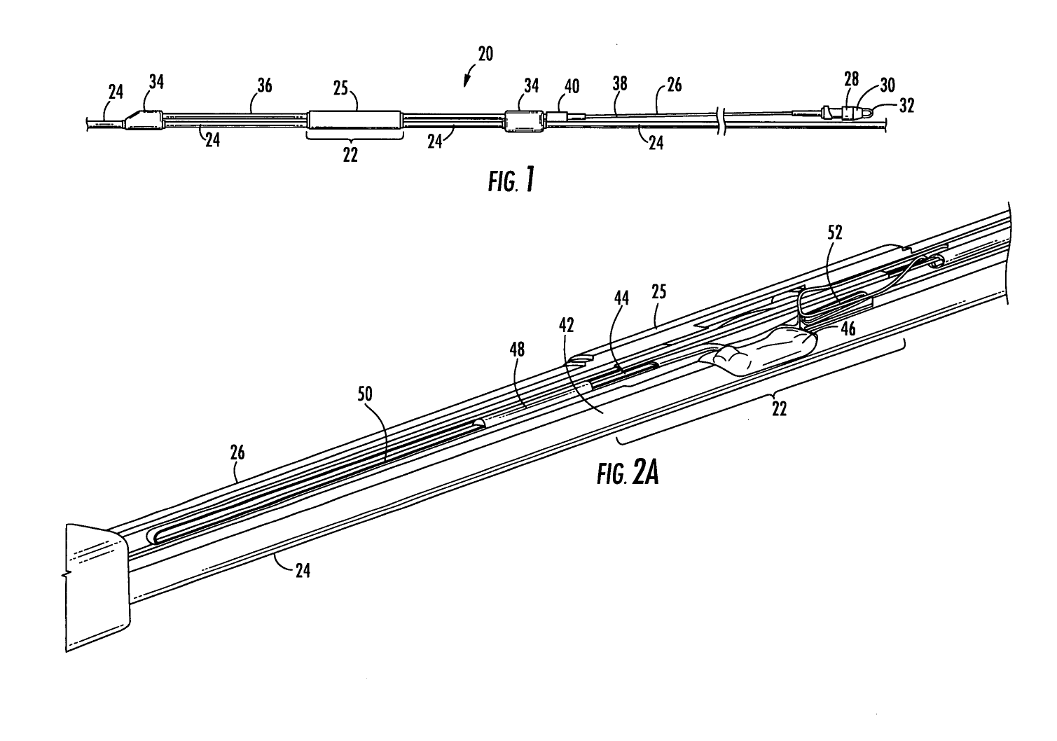

Referring to FIG. 1, one exemplary fiber optic cable assembly 20 of the present invention includes at least one NAP 22 positioned along the cable length for providing access to at least one optical fiber within the cable. The cable assembly 20 includes a distribution cable 24 and an external branching tether 26 attached about the NAP 22. The distribution cable typically includes a higher optical fiber count than an attached tether. The NAP 22 is shown substantially encapsulated within an overmolded body 25 sufficiently flexible to facilitate installation, and in some embodiments, not re-enterable without damaging the sealing integrity and structure of the body. In alternative embodiments, the overmolded body may be substituted with any other type of closure being able to bend about as much as the distribution cable 24, for example, a heat shrink closure may be used. The cable assembly is preferably less than about 2 inches in diameter, more preferably less than about 1.5 inches in diameter, even more preferably less than about 1.25 inches in diameter.

The tether 26 is selectively extendable, and in some embodiments retractable, and is used to extend the network to a desired location within reach of the tether without having to form slack loops. Thus, the length of the tether 26 is customizable as needed. As shown, the tether 26 telescopes and is maintained external to the distribution cable. Overmolded anchors 34 are used to maintain a portion of the tether 26 with the distribution cable 24. The anchors 34 may also be used to cover additional cable access points necessary for accessing enough preterminated fiber length for splicing. The anchors may be rigid clamshell structures, made from heat shrinkable material or may be overmolded bodies. The anchors may be flexible. The anchors may be streamline in shape to resist snagging during installation. The tether 26 may comprise a first tether portion 36 that slidingly and telescopically receives a second tether portion 38. A tether may include any number of telescoping components to achieve a desired tether length. Component travel may be limited using a stop or lanyard, as will be described in more detail below. Telescoping components may be substantially sealed using a component link 40.

Preterminated optical fibers at a NAP are spliced or otherwise optically connected to at least one optical fiber of the tether 26. Remaining uncut fibers of the distribution cable extend uninterrupted through the cable and are available for terminating at other downstream NAPs or at the cable end. A tether may be used to mitigate span-length measurement errors apparent after installation and provides branches off of the distribution cable for routing the network to locations within reach of a tether 26. Each tether may terminate in splice-ready fibers, connectorized fibers, a multi-port connection terminal or any tethered assembly. As shown, the tether 26 terminates in a plug 28 including a dust cap 30 with a pulling grip 32. The tether 26 may optionally terminate in a loopback device (not shown) used for line testing.

Various types of cables may be used to construct the cable assembly, such as monotube, loose tube, central tube, ribbon and the like. One example of a type of distribution cable suitable for use in conjunction with present invention is an ALTOS® dielectric cable available from Corning Cable Systems LLC of Hickory, N.C. The ALTOS® dielectric cable is a lightweight fiber optic cable designed for both buried (conduit) and aerial (lashed) deployments. In another example, the distribution cable shown is a Standard Single-Tube Ribbon (SST-Ribbon™) cable available from Corning Cable Systems LLC of Hickory, N.C. The SST-Ribbon™ cable contains readily identifiable twelve-fiber ribbons in a tube. Another example of a cable suitable for use with the present invention is the RPX™ ribbon cable also available from Corning Cable Systems. Cables suitable for the present invention should provide stable performance over a wide range of temperatures and be compatible with any type of optical fiber. Optical fibers of the present invention include, but are not limited to, single mode and multi-mode light waveguides, including one or more bare optical fibers, coated optical fibers, loose-tube optical fibers, tight-buffered optical fibers and ribbonized optical fibers. At least a portion of the cable assembly utilizes low bend sensitivity optical fiber, bend optimized optical fiber, bend insensitive optical fiber or photonic band gap fiber, all of which are referred to generically herein as “bend performance optical fiber.” Various types of cables may serve as a tether, such as monotube, loose tube, central tube and ribbon, and a tether may be disposed within another tubular body in a cable assembly.

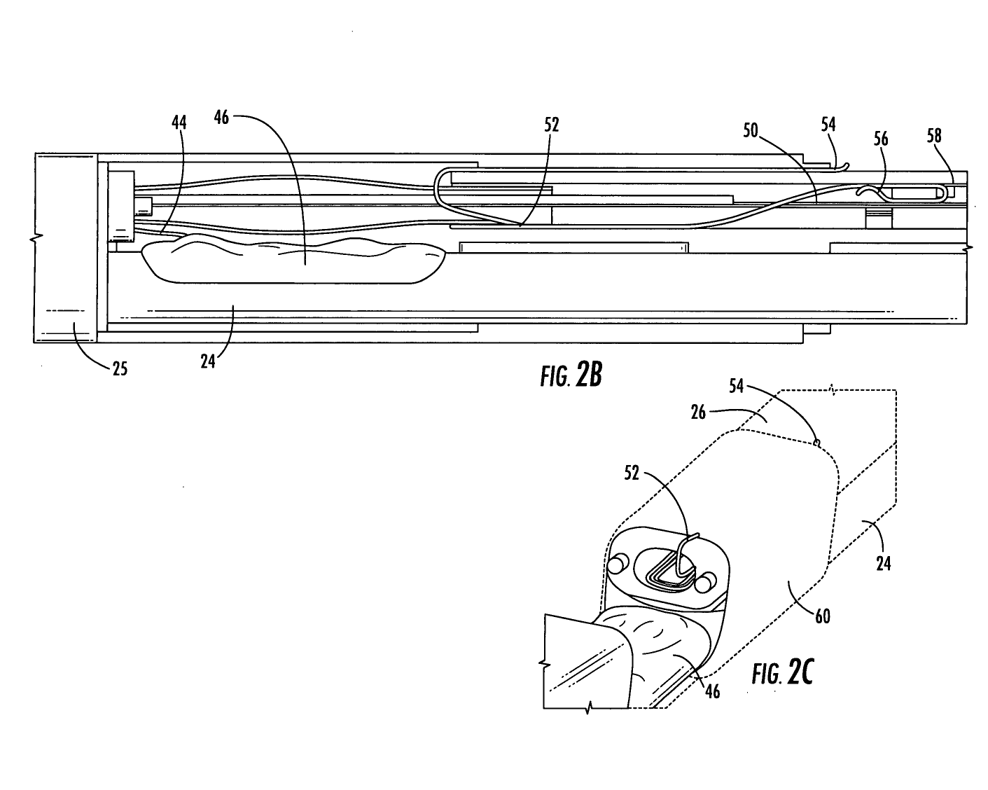

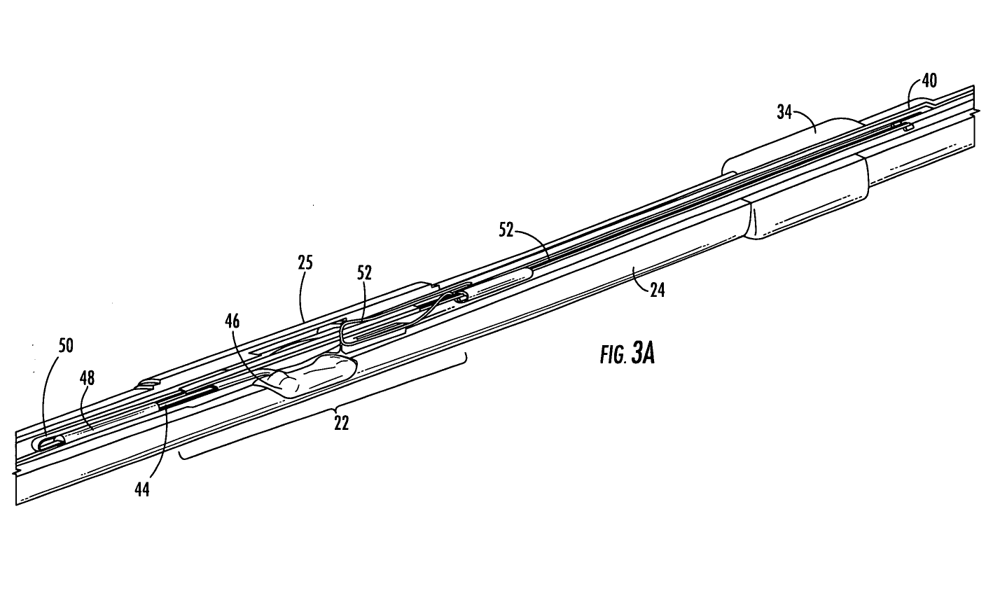

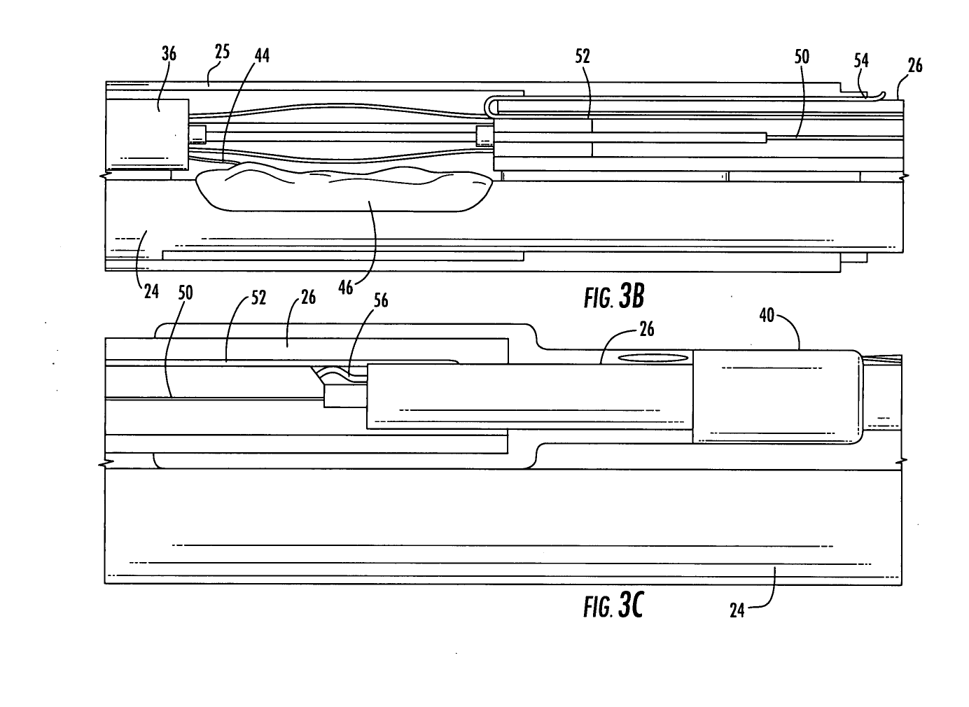

Referring to FIGS. 2A-C, the cable assembly is shown with the tether 26 in a retracted position. Portions of the overmolded body 25 and cable sheaths are removed to show the internal workings of the assembly. In one example of a method to create a mid-span access location, a section of the sheath 42 of the distribution cable 24 is removed to expose the ribbonized fibers within. One ribbon, for example, is selected, severed and routed away from the remaining ribbons and is referred to as the “preterminated ribbon 44.” The access point on the cable may be potted with a soft elastomer 46 or an epoxy to either lock down the remaining ribbons or allow them to float as desired. As described in more detail below, the preterminated ribbon is spliced to a length of bend performance fiber 50 at splice interface 48. A portion of the preterminated ribbon 44 is routed within the stationary portion, also referred to herein as the tether storage member, of the tether that forms a cavity used to store tether slack length. The bend performance fiber of the tether 26 is maintained within the stationary and moving portions of the tether 26 and forms a loop, coil or 180 degree turn therein. The turn allows for tether length to be stored, thus allowing portions of the tether 26 to be extended or retracted as desired. The bend performance fiber may perform multiple 180 degree turns to store a greater amount of tether slack.

Referring specifically to FIGS. 2B-C, a lanyard 52 limits the extension of the telescoping tether components relative to each other and prevents the fibers and splice interface from being strained. In one embodiment, the lanyard 52 prevents travel of the telescoping tether beyond a point that would longitudinally extend the bend performance fiber 50 and eliminate the 180 degree turn. Thus, the lanyard maintains the 180 degree turn to facilitate extending and retracting as desired. The lanyard 52 is secured about the assembly at one end 54 by a heat shrink 60, anchor or overmolded body. The lanyard 52 has a length sufficient to allow the tether 26 to be fully extended without allowing over-extension. As shown, the lanyard 52 length is coiled within a portion of the tether 26. The other end 56 of the lanyard 52 is secured about a moving portion 58 of the tether. The lanyard may be stored at an end of the cavity and deployed parallel to a length or ribbon slack as the tether is telescoped forward. The lanyard may include, but is not limited to, a single strand of Kevlar.

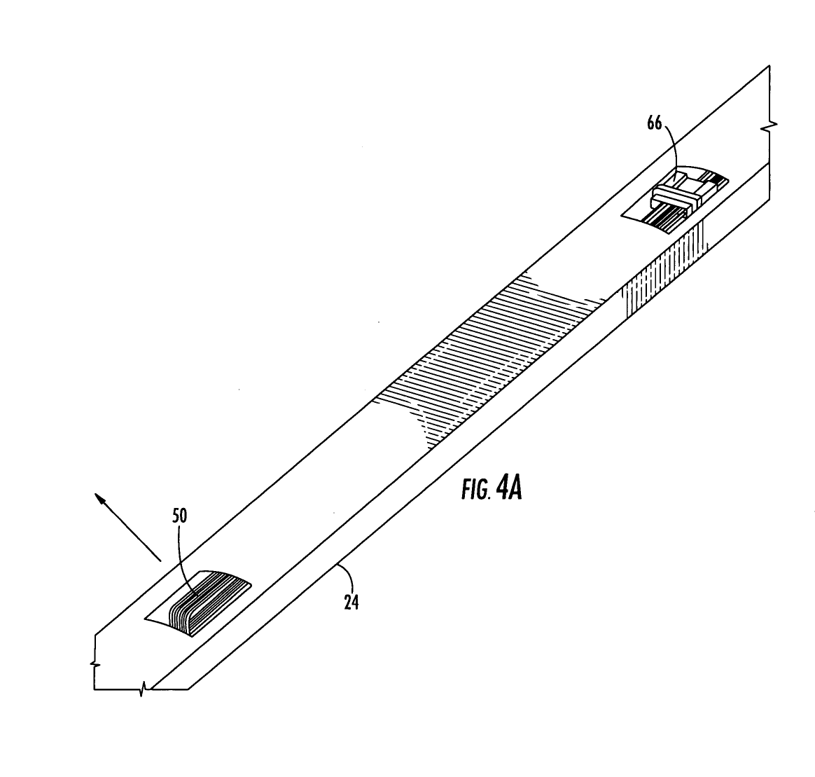

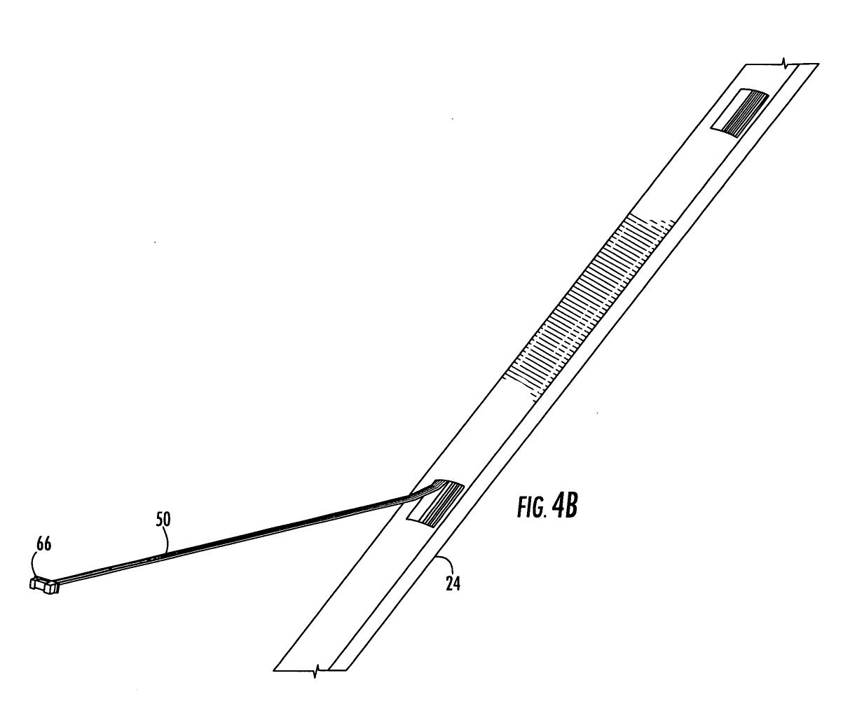

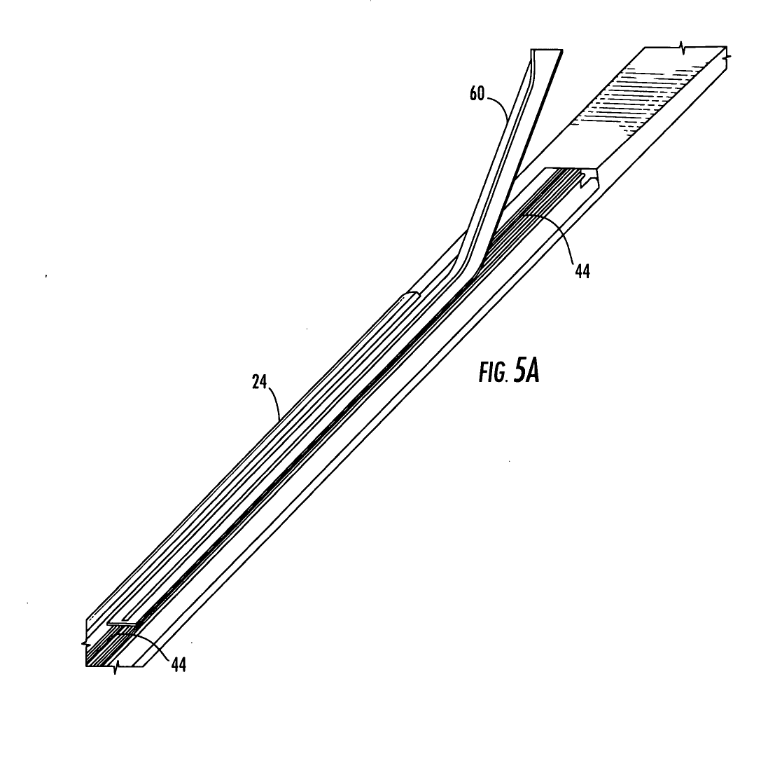

Referring to FIGS. 3A-C, the cable assembly is shown with the tether 26 in an extended position. Portions of the overmolded body 25 and cable sheaths are removed to show the internal workings of the assembly. The tether 26 is extended or telescoped by extending tether components slidably maintained within other tether components. In one embodiment, the components are tube-shaped and have varying diameters such that certain components fit within others. Component interfaces may be substantially sealed at links 40 that may be elastic boots. While the lanyard 52 provides and extension stop, in alternative embodiments, the boots may provide the extension stop. In the extended position, the 180 degree turn is still present in the bend performance fiber portion 50. Thus, extending and retracting the tether 26 results in the movement of the bend performance fiber portion of the assembly, and not the splice interface 48 or preterminated fiber portion 44, at least not an appreciable amount. The tether 26 may be extended/retracted as desired without having to access the internal portions of the assembly, thus, the overmolded body 25 is not re-entered. The total tether length 26 is dependent upon the stationary, slack storing component length and/or the number of telescoping components. It is envisioned that the tether may be capable of extending to any desired length. Tether components may be empty cables similar in design to the distribution cable of the assembly. Extension may be released using a ripcord or other mechanism.

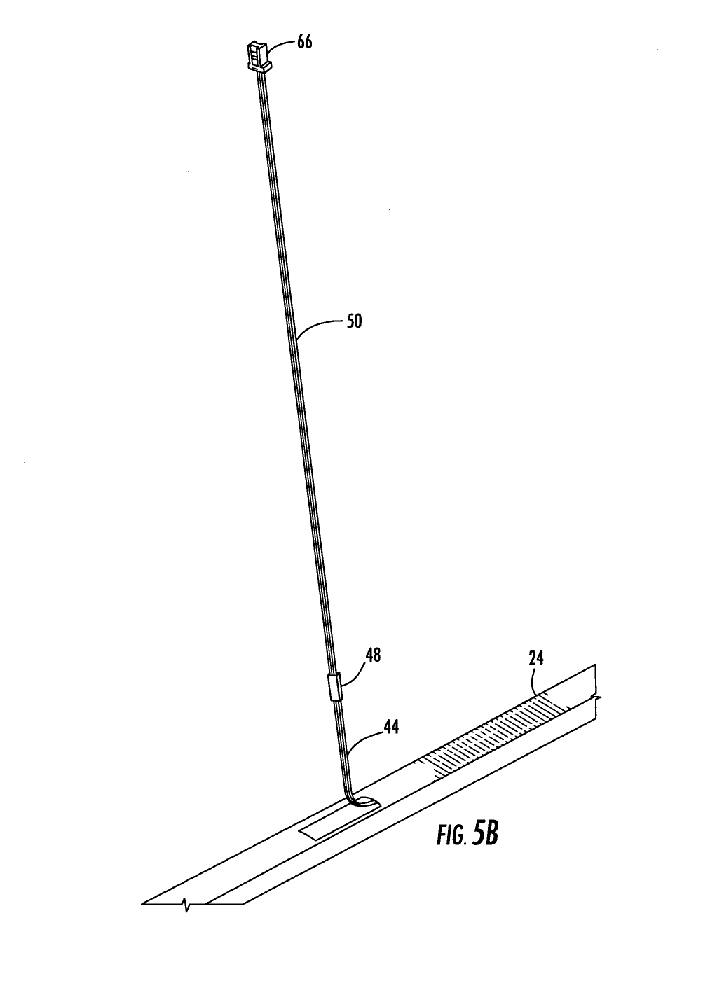

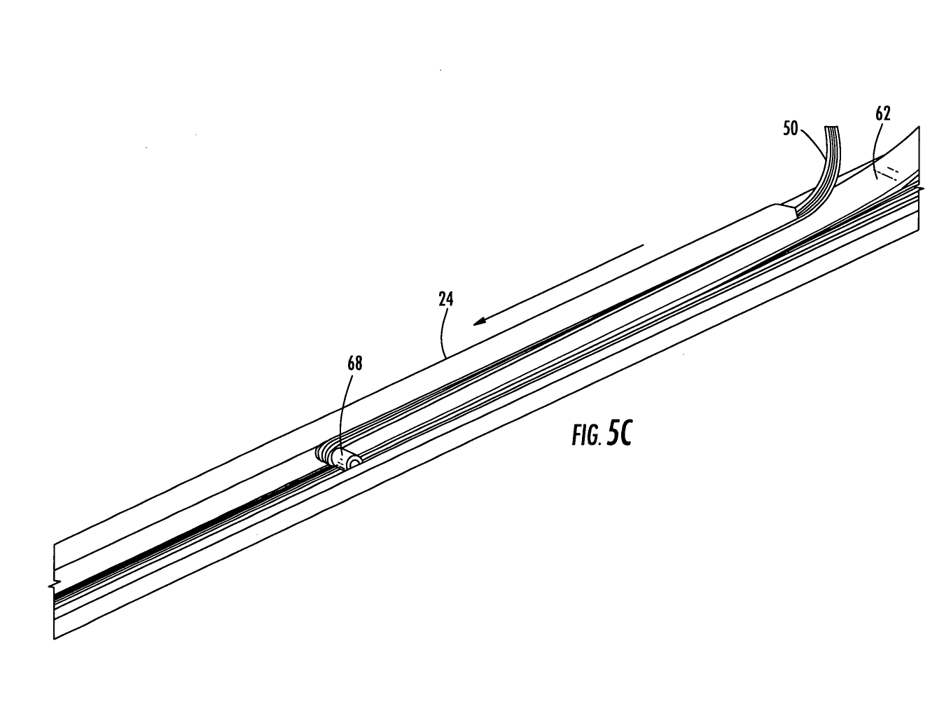

Referring to FIGS. 4A-B, another embodiment of a cable assembly is shown, wherein the tether length is stored internally within the distribution cable. The folded ribbon portion 50 shown comprises bend performance fiber capable of making a 180 degree turn within the diameter limitation. The ribbon terminates in a connector 66 and is maintained within the cable sheath along with the other uncut ribbons and withdrawn as needed. As shown, the tether 26 is a bare ribbon not protected within a tube. Once withdrawn, a protective tube may be applied. The tether is preferably extended such that the 180 degree turn is not extended, thus, the tether is capable of being retracted by sliding it back into the cable 24, leaving the splice interface within the cable.

Referring to FIGS. 5A-C, assembly steps are shown for accessing pre-selected fibers, splicing to a length of bend performance fiber, and re-inserting the tether back into the cable. Referring specifically to FIG. 5A, a tool 60 is used to sever the pre-selected fibers to form the preterminated portion. The tool 60 is inserted through a cable access portion, slid down the cable length to a desired position, and severs the ribbon. Referring to FIG. 5B, the preterminated ribbon portion 44 is withdrawn from the cable 24 and spliced to a length of bend performance fiber 50 capable of forming a 180 degree turn. Referring to FIG. 5C, the spliced ribbon is then re-inserted using another tool 62. In one embodiment, the tool 62 comprises a push or roller 68 used to push the ribbon fold into the cavity. The cable access point may then be covered with a protective removable coating and installed. Once needed, the tether is accessed through the cable access point and a desired length withdrawn to perform the interconnection.

One example of bend performance optical fiber suitable for forming loops or 180 degree turns within the present invention is a microstructured optical fiber comprising a core region and a cladding region surrounding the core region, the cladding region comprising an annular hole-containing region comprised of non-periodically disposed holes such that the optical fiber is capable of single mode transmission at one or more wavelengths in one or more operating wavelength ranges. The core region and cladding region provide improved bend resistance, and single mode operation at wavelengths preferably greater than or equal to 1500 nm, in some embodiments also greater than about 1310 nm, in other embodiments also greater than 1260 nm. The optical fibers provide a mode field at a wavelength of 1310 nm preferably greater than 8.0 microns, more preferably between about 8.0 and 10.0 microns. In preferred embodiments, optical fiber disclosed herein is thus single-mode transmission optical fiber.

In some embodiments, the microstructured optical fiber disclosed herein comprises a core region disposed about a longitudinal centerline, and a cladding region surrounding the core region, the cladding region comprising an annular hole-containing region comprised of non-periodically disposed holes, wherein the annular hole-containing region has a maximum radial width of less than 12 microns, the annular hole-containing region has a regional void area percent of less than about 30 percent, and the non-periodically disposed holes have a mean diameter of less than 1550 nm.

By “non-periodically disposed” or “non-periodic distribution”, we mean that when one takes a cross-section (such as a cross-section perpendicular to the longitudinal axis) of the optical fiber, the non-periodically disposed holes are randomly or non-periodically distributed across a portion of the fiber. Similar cross sections taken at different points along the length of the fiber will reveal different cross-sectional hole patterns, i.e., various cross-sections will have different hole patterns, wherein the distributions of holes and sizes of holes do not match. That is, the voids or holes are non-periodic, i.e., they are not periodically disposed within the fiber structure. These holes are stretched (elongated) along the length (i.e. in a direction generally parallel to the longitudinal axis) of the optical fiber, but do not extend the entire length of the entire fiber for typical lengths of transmission fiber.

For a variety of applications, it is desirable for the holes to be formed such that greater than about 95% of and preferably all of the holes exhibit a mean hole size in the cladding for the optical fiber which is less than 1550 nm, more preferably less than 775 nm, most preferably less than 390 nm. Likewise, it is preferable that the maximum diameter of the holes in the fiber be less than 7000 nm, more preferably less than 2000 nm, and even more preferably less than 1550 nm, and most preferably less than 775 nm. In some embodiments, the fibers disclosed herein have fewer than 5000 holes, in some embodiments also fewer than 1000 holes, and in other embodiments the total number of holes is fewer than 500 holes in a given optical fiber perpendicular cross-section. Of course, the most preferred fibers will exhibit combinations of these characteristics. Thus, for example, one particularly preferred embodiment of optical fiber would exhibit fewer than 200 holes in the optical fiber, the holes having a maximum diameter less than 1550 nm and a mean diameter less than 775 nm, although useful and bend resistant optical fibers can be achieved using larger and greater numbers of holes. The hole number, mean diameter, max diameter, and total void area percent of holes can all be calculated with the help of a scanning electron microscope at a magnification of about 800× and image analysis software, such as ImagePro, which is available from Media Cybernetics, Inc. of Silver Spring, Md., USA.

The optical fiber disclosed herein may or may not include germania or fluorine to also adjust the refractive index of the core and or cladding of the optical fiber, but these dopants can also be avoided in the intermediate annular region and instead, the holes (in combination with any gas or gases that may be disposed within the holes) can be used to adjust the manner in which light is guided down the core of the fiber. The hole-containing region may consist of undoped (pure) silica, thereby completely avoiding the use of any dopants in the hole-containing region, to achieve a decreased refractive index, or the hole-containing region may comprise doped silica, e.g. fluorine-doped silica having a plurality of holes.

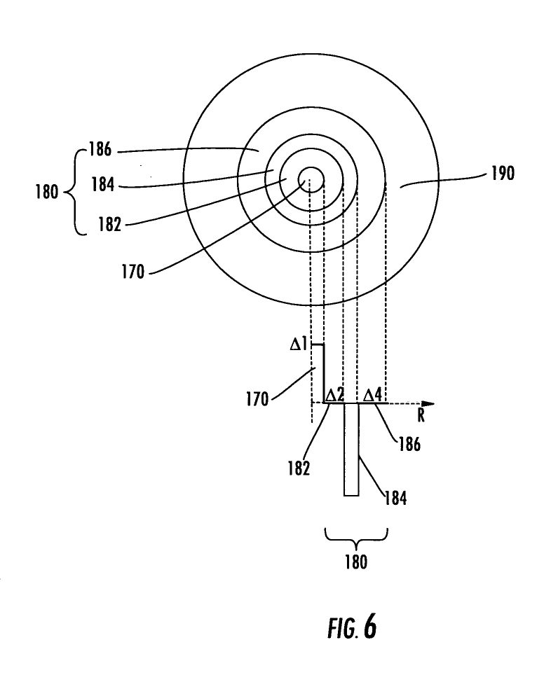

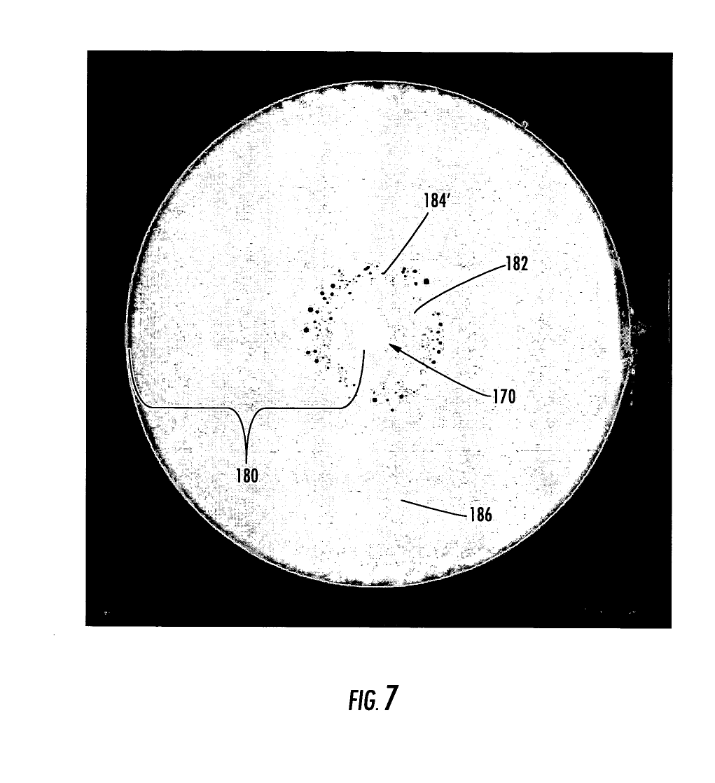

In one set of embodiments, the core region includes doped silica to provide a positive refractive index relative to pure silica, e.g. germania doped silica. The core region is preferably hole-free. As illustrated in FIG. 6, in some embodiments, the core region 170 comprises a single core segment having a positive maximum refractive index relative to pure silica Δ₁ in %, and the single core segment extends from the centerline to a radius R₁. In one set of embodiments, 0.30%<Δ₁<0.40%, and 3.0 μm<R₁<5.0 μm. In some embodiments, the single core segment has a refractive index profile with an alpha shape, where alpha is 6 or more, and in some embodiments alpha is 8 or more. In some embodiments, the inner annular hole-free region 182 extends from the core region to a radius R₂, wherein the inner annular hole-free region has a radial width W12, equal to R2−R1, and W12 is greater than 1 μm. Radius R2 is preferably greater than 5 μm, more preferably greater than 6 μm. The intermediate annular hole-containing region 184 extends radially outward from R2 to radius R3 and has a radial width W23, equal to R3−R2. The outer annular region 186 extends radially outward from R3 to radius R4. Radius R4 is the outermost radius of the silica portion of the optical fiber. One or more coatings may be applied to the external surface of the silica portion of the optical fiber, starting at R4, the outermost diameter or outermost periphery of the glass part of the fiber. The core region 170 and the cladding region 180 are preferably comprised of silica. The core region 170 is preferably silica doped with one or more dopants. Preferably, the core region 170 is hole-free. The hole-containing region 184 has an inner radius R2 which is not more than 20 μm. In some embodiments, R2 is not less than 10 μm and not greater than 20 μm. In other embodiments, R2 is not less than 10 μm and not greater than 18 μm. In other embodiments, R2 is not less than 10 μm and not greater than 14 μm. Again, while not being limited to any particular width, the hole-containing region 184 has a radial width W23 which is not less than 0.5 μm. In some embodiments, W23 is not less than 0.5 μm and not greater than 20 μm. In other embodiments, W23 is not less than 2 μm and not greater than 12 μm. In other embodiments, W23 is not less than 2 μm and not greater than 10 μm.

Such fiber can be made to exhibit a fiber cutoff of less than 1400 nm, more preferably less than 1310 nm, a 20 mm macrobend induced loss at 1550 nm of less than 1 dB/turn, preferably less than 0.5 dB/turn, even more preferably less than 0.1 dB/turn, still more preferably less than 0.05 dB/turn, yet more preferably less than 0.03 dB/turn, and even still more preferably less than 0.02 dB/turn, a 12 mm macrobend induced loss at 1550 nm of less than 5 dB/turn, preferably less than 1 dB/turn, more preferably less than 0.5 dB/turn, even more preferably less than 0.2 dB/turn, still more preferably less than 0.01 dB/turn, still even more preferably less than 0.05 dB/turn, and a 8 mm macrobend induced loss at 1550 nm of less than 5 dB/turn, preferably less than 1 dB/turn, more preferably less than 0.5 dB/turn, and even more preferably less than 0.2 dB-turn, and still even more preferably less than 0.1 dB/turn.

An example of a suitable fiber is illustrated in FIG. 7. The fiber in FIG. 7 comprises a core region that is surrounded by a cladding region that comprises randomly disposed voids which are contained within an annular region spaced from the core and positioned to be effective to guide light along the core region. Other optical fibers and microstructured fibers may be used in the present invention. Additional features of the microstructured optical fibers of additional embodiments of the present invention are described more fully in pending U.S. patent application Ser. No. 11/583,098 filed Oct. 18, 2006, and Provisional U.S. patent application Ser. No. 60/817,863 filed Jun. 30, 2006; 60/817,721 filed Jun. 30, 2006; 60/841,458 filed Aug. 31, 2006; and 60/841,490 filed Aug. 31, 2006; all of which are assigned to Corning Incorporated and the disclosures of which are incorporated by reference herein.

In the various cable assembly embodiments, an overmolding process may involve preparing the sheath of the distribution cable 24 in a manner known in the art, such as by cleaning, roughening, flame preparing or chemically preparing the surface of the sheath. The overmolding process may involve placing a portion of the cable assembly including the mid-span access location to be encapsulated into an overmolding tool. Materials suitable for overmolding may include, but are not limited to, polyurethane, silicone and like materials. The overmolded body provides a protective covering, provides sealing and is capable of withstanding crush forces up to at least about 300 lbs. The degree of flexibility of an access location may depend upon the material chosen and the geometry of the underlying components. In all embodiments, the overmolded body may have any desired shape, however, the preferred shape is low profile with tapered to avoid snagging during installation.

The foregoing is a description of various embodiments of the invention that are given here by way of example only. Although cable assemblies having flexible mid-span access locations and extendable/retractable tethers including bend performance fiber have been described with reference to preferred embodiments and examples thereof, other embodiments and examples may perform similar functions and/or achieve similar results. All such equivalent embodiments and examples are within the spirit and scope of the present invention and are intended to be covered by the appended claims.

1. A cable assembly including a fiber optic cable and at least one network access point positioned on the cable at which at least one optical fiber within the cable is accessed and preterminated, the cable assembly comprising:
a tether adapted to be selectively extended relative to the network access point and including at least one tether optical fiber therein that is optically connected to the at least one preterminated optical fiber; and
a tether storage member for storing at least a portion of the tether therein, wherein the tether portion is moveable therein;
wherein at least one of the at least one preterminated optical fiber and the at least one tether optical fiber comprises a bend performance optical fiber.

2. The cable assembly of claim 1, wherein the tether is adapted to be selectively retracted.

3. The cable assembly of claim 1, wherein the bend performance optical fiber performs at least one 180 degree turn or loop within the tether storage member.

4. The cable assembly of claim 1, further comprising a body substantially enclosing the at least one network access point.

5. The cable assembly of claim 4, wherein the body is an overmolded body.

6. The cable assembly of claim 4, wherein the body is flexible.

7. The cable assembly of claim 4, wherein the body secures at least a portion of the tether storage member.

8. The cable assembly of claim 1, wherein the tether is preconnectorized.

9. The cable assembly of claim 1, further comprising a lanyard for limiting the extension of the tether.

10. The cable assembly of claim 1, wherein the tether storage member is internal to the fiber optic cable.

11. The cable assembly of claim 1, wherein the tether storage member is external to the fiber optic cable.

12. The cable assembly of claim 1, wherein the bend performance optical fiber is a microstructured optical fiber comprising a core region and a cladding region surrounding the core region, the cladding region comprising an annular hole-containing region comprised of non-periodically disposed holes and the microstructured fiber having a 12 mm macrobend induced loss at 1550 nm of less than 0.1 dB/turn.

13. The cable assembly of claim 1, wherein the bend performance optical fiber is a microstructured optical fiber comprising a core region and a cladding region surrounding the core region, the cladding region comprising an annular hole-containing region comprised of non-periodically disposed holes and the microstructured fiber having a 12 mm macrobend induced loss at 1550 nm of less than 0.05 dB/turn.

14. The cable assembly of claim 1, wherein the bend performance optical fiber is a microstructured optical fiber comprising a core region and a cladding region surrounding the core region, the cladding region comprising an annular hole-containing region comprised of non-periodically disposed holes and the microstructured fiber having an 8 mm macrobend induced loss at 1550 nm of less than 0.2 dB/turn.

15. The cable assembly of claim 1, wherein the bend performance optical fiber is a microstructured optical fiber comprising a core region and a cladding region surrounding the core region, the cladding region comprising an annular hole-containing region comprised of non-periodically disposed holes and the microstructured fiber having an 8 mm macrobend induced loss at 1550 nm of less than 0.1 dB/turn.

16. A cable assembly including a fiber optic cable and at least one network access point positioned on the cable at which at least one optical fiber within the cable is accessed and preterminated, the cable assembly comprising:
a connectorized tether including a first tether portion that is stationary, a second tether portion that is adapted to be selectively extended relative to the network access point and to the first tether portion, and at least one tether optical fiber therein that is spliced to the at least one preterminated optical fiber;
wherein at least one of the at least one preterminated optical fiber and the at least one tether optical fiber being a bend performance optical fiber.

17. The cable assembly of claim 16, wherein the second tether portion is adapted to be selectively retracted.

18. The cable assembly of claim 16, wherein the bend performance optical fiber performs at least one 180 degree turn or loop within the first tether portion.

19. The cable assembly of claim 16, further comprising a flexible body substantially encapsulating the at least one network access point.

20. The cable assembly of claim 16, further comprising a lanyard for limiting the extension of the tether.

21. The cable assembly of claim 16, wherein the first tether portion is internal to the fiber optic cable.

22. The cable assembly of claim 16, wherein the first tether portion is external to the fiber optic cable.

23. The cable assembly of claim 16, wherein the bend performance optical fiber is a microstructured optical fiber comprising a core region and a cladding region surrounding the core region, the cladding region comprising an annular hole-containing region comprised of non-periodically disposed holes.

24. The cable assembly of claim 16, wherein tether extension is enabled by telescoping elements.

25. A cable assembly including a fiber optic cable and at least one network access point positioned on the cable at which at least one optical fiber within the cable is accessed and preterminated, the cable assembly comprising:
a tether adapted to be selectively extended relative to the network point and including at least one tether optical fiber therein that is optically connected to the at least one preterminated optical fiber, the at least one tether fiber comprising a microstructured optical fiber comprising a core region and a cladding region surrounding the core region, the cladding region comprising an annular hole-containing region comprised of non-periodically disposed holes; and
a tether storage member for storing at least a portion of the tether therein.

26. The cable assembly of claim 25, wherein the microstructured fiber has a 12 mm macrobend induced loss at 1550 nm of less than 0.05 dB/turn.

27. The cable assembly of claim 25, wherein the microstructured fiber has a 8 mm macrobend induced loss at 1550 nm of less than 0.1 dB/turn.

28. The cable assembly of claim 25, wherein the tether is adapted to be selectively retracted.

29. The cable assembly of claim 25, wherein the tether storage member is internal to the fiber optic cable.

30. The cable assembly of claim 25, wherein the tether storage member is external to the fiber optic cable.
